(19) United States
(12) Patent Application Publication
(10) Pub. No.: US 2008/0260176 A1
(43) Pub. Date: Oct. 23, 2008

(54) System and Method For Controlling a Device Using Position and Touch

(75) Inventors: Gerrit Hollemans, Eindhoven (NL); Vincent P. Buil, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/091,585

(22) PCT Filed: Oct. 27, 2006
(86) PCT No.: PCT/IB2006/053991

§ 371 Date: Apr. 25, 2008

Related U.S. Application Data
(60) Provisional application No. 60/730,972, filed on Oct. 28, 2005.

(51) Int. Cl. H04R 1/10

(52) U.S. Cl. 381/74

(57) ABSTRACT

Disclosed is a system for controlling a device comprising at least one earpiece for selecting/rendering media content, wherein a first earpiece includes a first input controller for receiving input to control the selecting/rendering, a first position controller for detecting whether the first earpiece is in/on the ear and receiving input to control the selecting/rendering of the media content, wherein the system is arranged to use a position detection from the first position controller or a combination of a position detection from the first position controller and an input from the first input controller to enable control of the media content selecting/rendering.

The invention relates to a system and method for controlling a device. In particular, the system and method uses position and touch of a user interface (e.g. an earpiece) for controlling the device.

It is ? known to incorporate a touch-sensitive area in an earpiece. For example, in published PCT patent application WO 2004/093490 A1, an audio entertainment system is described with an audio device and two earpieces for transducing audio. A first earpiece has a controller with input means for controlling the audio device. The input means have a touch-sensitive area. Based on a detection of the touch-sensitive area being touched, the audio device is controlled by means of a control signal sent from the controller to the audio device. This prevents the hassle involved in finding, manipulating and operating a conventional control that is typically dangling somewhere along a wire. The patent application also describes how to prevent accidental control actions. The earpiece may therefore have a further touch-sensitive area that makes contact with the skin when the earpiece is being worn in or by the ear. The earpiece only sends the control signal if the further touch-sensitive area makes contact. For usability reasons, the number of tapping patterns that can be used for application commands is limited to three, namely single tap, double tap, and holding the earpiece. Given that the commands can be different for the two earpieces, there are on total six commands that can be activated using tapping on touch headphones.

Further, non-prepublished PCT patent application WO IB2005/051034 describes a headphone that is equipped with touch controls, functioning as a remote control unit for a portable device. By tapping once, twice, or for a prolonged period of time, on the left or right earpiece, different commands can be given to the player, such as play, pause, next/previous, and volume up/down, phone controls, etc. These touch headphones combine multiple buttons into one (thus searching is not need with the tactile senses, nor is as much space needed on the headphone), and makes it lightly operable (important for in-ear headphones).

Although, WO IB2005/051034 describes the use of sensors embedded in the earpieces that are used to detect whether the earpieces are ‘in’ or ‘on’ the ears. This is used in combination with the other sensors and particular rules to implement an automatic control lock. This enables the system to prevent that the touch headphones inadvertently activate commands, e.g., when the user is transporting the headphones in her pocket.

Both systems described above offer only a limited number of controls. For several applications (audio playback, radio listening, mobile phone use) that are used when the user is moving about (walking, cycling, driving) six patterns may be enough, given a careful selection of the commands that need to be enabled and the mapping of the commands to the different patterns.

While each of the different applications can be catered for, in some cases this can be automatic, e.g., when there is an incoming call, however, there is still the need to enable the user to switch between applications. Thus, there is a need in the art for additional input mechanism to enable additional functionality of a device, e.g. for those cases where the application switching needs to be under the user's control, etc.

The present invention reduces or overcomes these limitations. The invention provides a system and method that provides additional functionality of a device using a position and touch input or control mechanism. In particular, a system is provided to control a device comprising at least one earpiece for selecting/rendering media content, wherein a first earpiece has a first input controller for receiving input to control the selecting/rendering, a first position controller for detecting the first earpiece and receiving input to control the selecting/rendering of the media content, wherein the system is arranged to use position detection from the first position controller or a combination of position detection from the first position controller and an input from the first input controller to enable control of the media content selecting/rendering. In one illustrative embodiment, the position controller is a touch sensor detecting whether the earpiece is in/on the ear, and that the input controller is a touch sensor detecting whether the user touches it by hand.

The present invention will be more apparent from the following description with reference to the drawings.

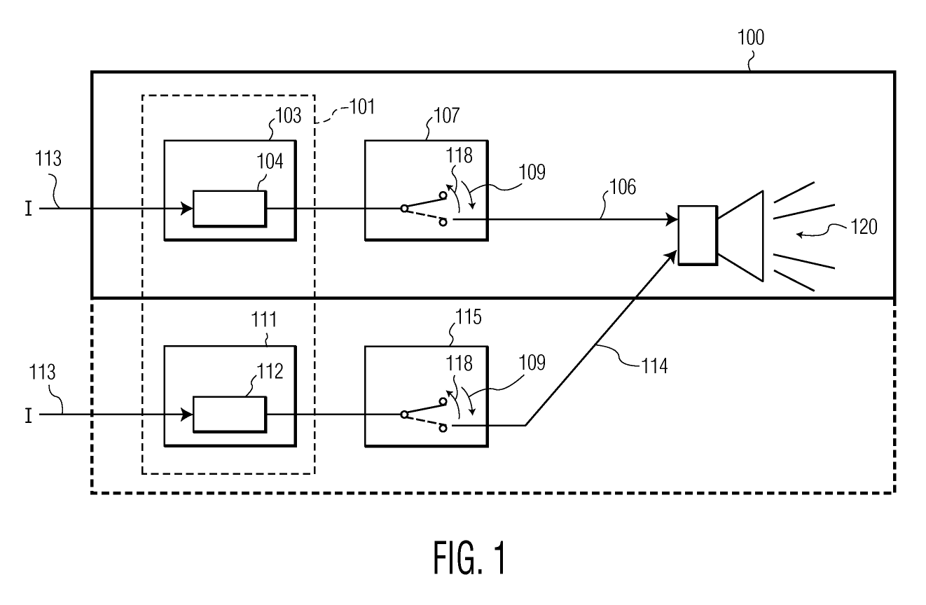

FIG. 1 shows a block diagram of an audio entertainment system 100 according to the invention.

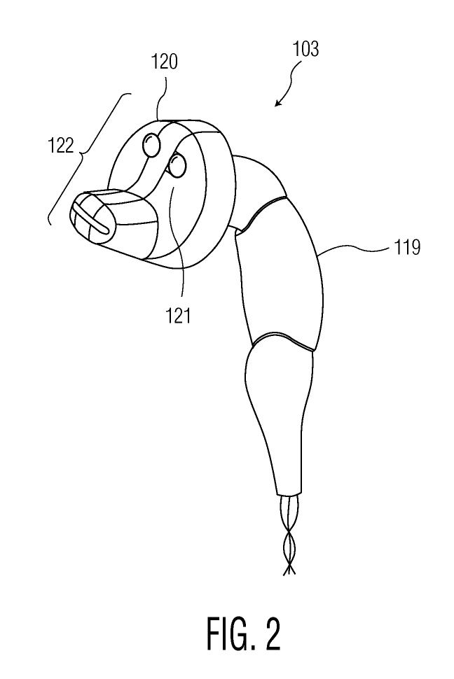

FIG. 2 shows a close-up of touch areas 119, 120, 121, 122 of an earpiece 103 according to the invention.

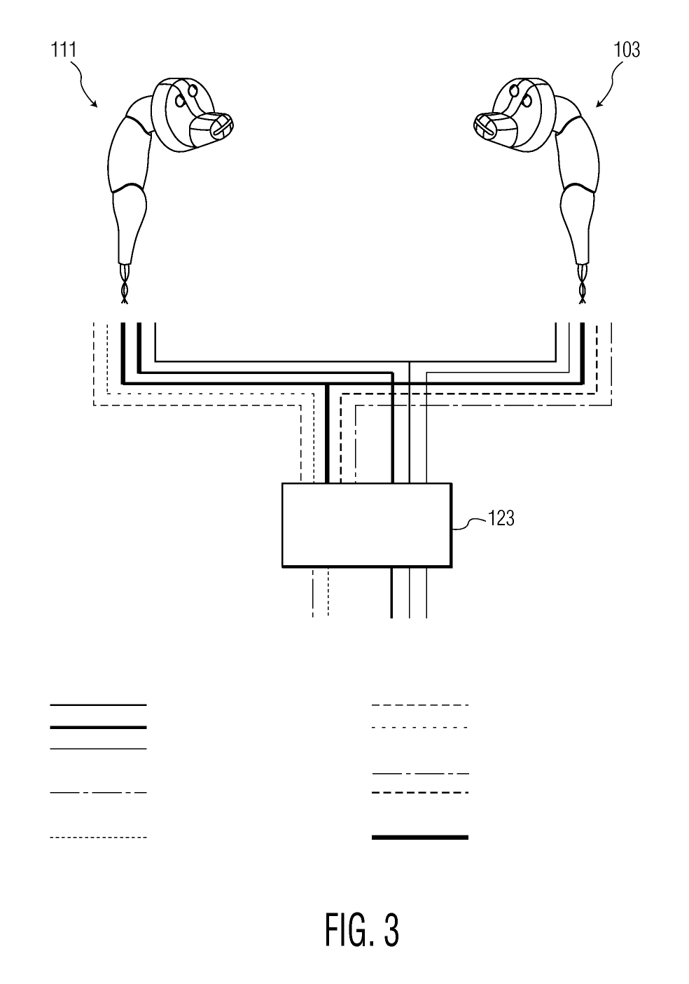

FIG. 3 shows an example of wiring the headphones 103, 111 according to the invention.

Hereinafter, preferred embodiments of the present invention will be described with reference to the accompanying drawings. In the following description, the same elements will be designated by the same reference numerals although they are shown in different drawings. Further, various specific definitions found in the following description, such as specific values of packet identifications, contents of displayed information, etc., are provided only to help general understanding of the present invention, and it is apparent to those skilled in the art that the present invention can be implemented without such definitions. Further, in the following description of the present invention, a detailed description of known functions and configurations incorporated herein will be omitted when it may make the subject matter of the present invention rather unclear.

Referring to FIGS. 1 and 2, in the described embodiments, the system 100 comprises a device, for example a portable audio player, a set of earpieces 101 (in particular first earpiece 103 and second earpiece 111) for selecting/rendering media content, e.g. transducing the audio from the player, with a first earpiece 103 having a first input controller 104. In this embodiment, the set of earpieces 101 is also referred to as headset or headphone, but it may comprise several headphones for sharing audio in a group of people. The first and second input controllers 104, 112 comprise a touch-sensitive area 119, on the earpieces 103, 111. The touch-sensitive area 119 may receive input 113 for controlling 106, 114 the player, which adapts the audio transduced accordingly. The input 113 is also referred to as touching, tapping, and tapping action. The earpieces 103, 111 have a first position detector 107, 115. In this embodiment, the position detectors 107, 115 comprise a further touch-sensitive area 122, with a pair of skin contacts 120, 121. Both touch-sensitive areas consist of conductive material used as antennas for capacitive touch sensing, which is done in for example the QT1080 8-KEY QTouch™ SENSOR IC from Quantum Research (www.qprox.com). Note that this conductive material may be hidden underneath a layer of dielectric material to protect it from corrosion. If the earpieces 103, 111 are positioned for transducing audio, (i.e. “in position” if the earpiece 103 is inserted or worn by the ear and “out of position” if the earpieces 103, 111 are not inserted or worn by the ear), the skin creates a touch signal via antenna 122 for detecting the earpiece 103, 111 being positioned for transducing audio. The system 100 is arranged to use a position detection from the position controller 107, 115 or a combination of a position detection from a position controller 107, 115 and an input from a input controller 104, 112 to enable control of the media content selecting/rendering. The system 100 may be further arranged to disable the control action 106 and the further control action 114 if both the first and the second input means 112 receive input 113 simultaneously, via switch action 118, 109. The system 100 may be further arranged to disable the control action 106 with the first input means 104 as soon as the first earpiece 103 is detected to be no longer positioned for transducing audio 102, via switch action 118, 109.

The system may further comprise other input controller or other output device (not shown), for example, a video display, a game pad, or a keyboard. The audio entertainment system may comprise or be part of e.g. a gaming device, a communication device, a computing device, a personal digital assistant, a smartphone, a portable computer, a palmtop, a tablet computer, or an organizer.

The media content rendered/selected may be one or more software applications and may be generated in system 100, for example, by playing it from a medium, e.g. an optical disk such as a BluRay disc, a DVD, a CD, a hard-disc, a solid-state memory. The media content rendered/selected may alternatively or additionally be received by the audio entertainment system, for example, via a wireless interface, e.g. a wireless LAN, WiFi, UMTS, or via a wired interface, e.g. USB, FireWire, or via another interface.

The first earpiece 103 may be an in-ear type of headphone or earpiece, a headset with a boom, a headband with a cup, or another type of earpiece or headphone.

The first earpiece 103 has a first input controller for receiving input to control the media content selecting/rendering. First input controller 104 may be, for example, an electromechanical sensor, e.g. a switch, a button, an electronic sensor, e.g. a touch sensor, an electro-optical sensor, e.g. an infrared sensor, or a laser beetle. First input controller 104 may also be a speaker that transduces the audio, used as a microphone. Tapping the earpiece causes a particular noise, which may be picked up by the speaker, causing an electric signal, e.g. on terminals of the speaker. The signal may be detected by means of a detector for the particular noise. The detector is electrically coupled to the speaker.

The input received may be e.g. a switch-over, a push, a tap, a press, a movement, or a noise. The controlling may be e.g. increasing or decreasing a setting, for example, an audio volume, an audio balance, a tone color, or any setting for an audio effect like reverberation, chorus, etc. The control action may pertain to the audio, for example, selecting an audio source, e.g. an artist, an album, a track, a position in time of a track, or a play-back speed.

System 100 comprises a first position detector 107 for detecting the first earpiece 103 being positioned for media content selecting/rendering. The first position detector 107 may be based on an any of several operating principles, for example, closing an electric circuit between a pair of e.g. skin contacts, or spring switch contacts, detecting an infrared radiation, detecting the presence of an earlobe, and the like or another operating principle.

As shown in the FIG. 3, the system 100 may comprise a second earpiece 111. The second earpiece 111 comprises a second input controller 112 for receiving input 113 to further control 114 the selecting/rendering action (e.g. transducing audio). The second earpiece 111 also comprises a second position detector 115 for detecting the positioning 108 of the second earpiece 111 for transducing audio.

Adding touch-sensitive areas 119 to the headphone may require extra wires next to the audio lines. A total number of five wires may run down from each earpiece 103, 111 onto the point 123 where the wires come together. At this point 123, the touch events 113 may be converted into some analog or digital control signal to minimize possible disturbance of e.g. a mobile phone, as is further explained below. Furthermore, the touch-sensing electronics that buffer the signal may need some power at this point 123. Instead of an extra power line, the power may be ‘added’ to the audio signal and ‘subtracted’ again with capacitors at the ‘touch to control converter’ with relatively simple electronics.

The first and the second earpiece fit naturally in a right and a left ear, respectively, because of a substantial mirror symmetry between the first and the second earpiece. Alternatively, the first and the second earpiece may be substantially identical.

The invention may be applied, for example, for selection of an application actually controlled by the user via first and second position controllers 107, 115 and operating the deck-controls (play, pause, next, etc.) of a portable audio player via touch controls 119 on the headphones 103, 111.

The selection of an application includes a number of subtasks that need to be performed to enable application selection, these include: switching from any application to the application selection mode, selecting the next application, selecting the previous application (not always necessary, depends if the list of applications is circular), activating the application (and leave the application selection mode), leaving the application selection mode (cancel, i.e., leave without activating a different application, returning to the currently active application).

Table 1 is one illustrative example of mapping earpiece position to application selection subtask patterns (in all cases the available applications are placed in a circular list):

TABLE 1
Example of mapping earpiece position to application selection subtask patterns

| Subtask | method 1 | method 2 | method 3 | Method 4 | method 5 | method 6 |
|---|---|---|---|---|---|---|
| Enter | lift-off | lift-off and | lift-off | lift-off and | lift-off and | lift-off and |
| application | earpiece | return | and | return | return | return |
| switching | | earpiece | return | earpiece | earpiece | earpiece |
| mode | | | earpiece | | | |
| select next | System | return | Double | On return of | On return | On return |
| application | presents | earpiece¹ | tap right | earpiece | of earpiece | of earpiece |
| | applications | | | (double tap | (double tap | (double tap |
| | in turn using | | | right for | right for | right for |
| | spoken | | | additional | additional | additional |
| | feedback | | | ‘next’) | ‘next’) | ‘next’) |
| select | not possible | not | Double | double tap | double tap | double tap |
| previous | | possible | tap left | left | left | left before |
| application | | | | | | time-out |
| | | | | | | expires |
| activate | Return | return | tap right | time-out (or | tap right | On return |
| selected | earpiece | earpiece | | faster: tap | before | of earpiece |
| application | | | | on right | time-out | (application |
| | | | | earpiece) | expires | starts, controls |
| | | | | | | are enabled |
| | | | | | | after time- |
| | | | | | | out expires |
| | | | | | | or following |
| | | | | | | a right tap) |
| leave | Return | tap left | tap left | tap left | time-out | tap left |
| application | earpiece and | before | | before time- | (or faster: | before |
| switching | tap left | time-out | | out-expires | tap on left | time-out |
| mode | before time- | expires | | | earpiece) | expires |
| (cancel) | out expires | | | | | |

¹Lift off and return repeatedly as necessary to select an application that is further in the list of applications

The mapping presented in Table 1 are not all options that can be conceived and are presented as illustrative only. Thus, for example, method 1 requires the user to intervene in a system-paced process. This is, from a usability perspective, not a good solution. Method 2 enables the user to do the pacing, but requires the user to repeatedly lift-off and return one of the earpieces and may not acceptable or pleasant for the user. Furthermore, Method 2 provides no logical option to select the previous application. In a lift-off and return approach a predetermined length of time is used for a user to complete the lift-off and return of the earpiece, (e.g. 2 sec.). Method 3 offers the user the pacing and a logical ‘previous application’ command, but requires an extra step from the user to select the next application. Method 4 and 5 nicely eliminate the extra step for the ‘next application’ command and are interchangeable except for their respective emphasis on the ‘activate’ and ‘cancel’ commands. Method 4 does not require an explicit action from the user to activate the selected applications (but does allow the user to short-cut the time-out), whereas Method 5 emphasizes error prevention, requiring the user to confirm the selected application by a tap for activation. Method 6 follows a different philosophy, since the application is activated immediately on return of the earpiece. Within the time-out, the user can still cancel the application switch by tapping on the left earpiece. The time-out is a predetermined length of time e.g. a value between 2 and 5 sec. If a different application is desired, the user can still double tap on either side to select the next or previous application in the list, each time resetting the time-out. However, if the application switch was intended, the user can start enjoying the application immediately (e.g., music has started immediately). Interaction with the application is postponed until the time-out expires or until the user confirms the switch (after the fact), whichever one is first. This is done since otherwise part of the controls have an effect on application selection (double tap on either side and tap on left) whereas the other part of the controls have an effect on the activated application (tap on right, hold on either side).

The above Table 1 is presented as a single list from which the user can select. However, given that the headphones consist of two earpieces, the list can be split over the two sides. One list is linked to the right earpiece, one list is linked to the left earpiece. The user can traverse through these lists by touching the corresponding earpiece, e.g., a single tap to advance and a double tap to return a position in the respective list. When the desired application is selected, this is either activated by a time-out, or by an activation command by the user, e.g., hold on the respective earpiece.

In the above Table 1, it was not made explicit which one of the earpieces the user lifts off. Alternatively, it is possible to attach different meaning to lifting off the right or the left earpiece. For example, lifting off and returning the right earpiece might trigger the selection (and activation) of the next application in the list, whereas lifting off and returning the left earpiece might trigger the selection (and activation) of the previous application in the list. Repeatedly selecting ‘next’ or ‘previous’ (in a longer list of applications) requires that the user repeatedly lifts off and returns the earpiece.

The mapping of the user's tapping on the earpieces 103, 111 to actions of the player may follow two user interface design rules: (1) frequently used functionality should be easily accessible, and (2) follow the Western convention of left to decrease and right to increase values. In line with these rules, the mapping of the different tapping patterns 113 onto the player's deck and volume controls may be done as described in Table 22. Investigation indicates that people find this mapping intuitive and easy to learn.

TABLE 2
Example of mapping tapping patterns to deck and volume controls

| Tapping | Function on left | Function on right |
|---|---|---|
| pattern | earpiece | earpiece |
| Single tap | Pause | Play |
| Double tap | Previous track | Next track |
| Hold | Volume down | Volume up |
| Tap-and-hold | Fast rewind | Fast forward |

Another possibility is to map a single tap 113 on either earpiece 103, 111 to a toggle that alternates between a first state of playing and a second state of pausing. This has the advantage that both functions of pausing and playing are available at both earpieces 103, 111. This measure provides greater convenience of invoke both functions with one hand with this mapping.

Another automatic control function may be offered by the touch headphone when the headphone 103, 111 is taken off. In this case, the player may automatically pause playback, and when the headphone 103, 111 is put on, playback may automatically start, optionally resuming from the position where it paused. This is convenient, because it may avoid battery depletion when the user is not listening. Additionally, it may prevent the user missing a part of the music, for example, when talking briefly to someone in the street.

Still further automatic control function may be offered, for example, when a user lifts off the earpiece while readjusting it on her head, when a user lifts off the earpiece to temporarily listen or talk to someone. To deal with these two situations a first timer is used that measures the time between a lift-off event and a return event.

The length of this time determines whether the lift-off and return events results in entering the application switch mode or not:
1. If the time is <1 second, then the events are ignored and are assumed to be the result of refitting the headphones to the ears
2. If the time is >=1 second and <2 seconds, the events will result in entering the application switch mode
3. If the time is >=2 seconds, then the events are ignored and are assumed to be the result of the user lifting off the headphone for listening to a conversation, or taking off the headphone completely

Only when the application switch mode is started, does the second timer start (generating the time-out discussed in Table 1). If there is no further user event before this timer reaches a predetermined value (e.g. 3 sec.), then the actual application selection is performed, or canceled, dependent on the method used (4, 5 or 6) as described in Table 1.

The values of 1, 2, and 3 seconds as given above are illustrative only, and are not meant to limit the invention. Further, the time outs may be different for the right and the left earpiece. Theses values should be determined by proper evaluation with end-users depending on a particular application of the invention. There is a requirement that the user should not have to lift-off for a long time to activate the application selection. However, when choosing a much lower value then the 1 sec. discussed above, the drawback is that inadvertent activation of the application selection mode can happen when the user is refitting the earpieces of the headphones. This may not be as serious as it seems though. Firstly, the user can actively cancel the application selection. Secondly, the user can learn to adjust the headphones without lift-off.

To further enhance the system, the controlled device may provide immediate acoustic feedback in response to an action. One example of such feedback is providing an audible hum or beep in response to a position change or tap. Another example is that the audio feedback represents the activated function of the device, for example, by varying volume, pitch, rhythm or melody or combinations thereof of the audio feedback. Yet another example of feedback is the use of a recorded or synthesized human voice informing the user about the activated function of the device or about the capabilities of the device and how to control them.

It is noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “have” or “comprise” and its conjugations does not exclude the presence of elements or steps other than those stated in a claim. Use of the article “a” or “an” preceding an element does not exclude the presence of a plurality of such elements. The invention can be implemented by means of hardware comprising several distinct elements, and by means of a suitably programmed computer. In the entertainment device claim enumerating several means, several of these means can be embodied by one and the same item of hardware. The mere fact that certain measures are recited in mutually different dependent claims does not indicate that a combination of these measures cannot be used to advantage.

1. A system for controlling a device comprising:
at least one earpiece for selecting/rendering media content, wherein a first earpiece includes a first input controller for receiving input to control the selecting/rendering;
a first position controller for detecting the first earpiece and receiving input to control the selecting/rendering of the media content;
wherein the system is arranged to use a position detection from the first position controller or a combination of a position detection from the first position controller and an input from the first input controller to enable control of the media content selecting/rendering.

2. The system as claimed in claim 1, wherein the system further comprises:
a second earpiece having a second input controller for receiving input to further control the selecting/rendering of media content; and
a second position controller for detecting the second earpiece and receiving input to control the media content selecting/rendering;
wherein the system is arranged to use a position detection from the first or second position controller or a combination of a position detection from the first or second position controller and an input from the first or second input controller to enable control of the media content selecting/rendering.

3. The system as claimed in claim 1, wherein the first position controller is a capacitive touch-sensing device.

4. The system as claimed in claim 1, wherein the first position controller is based on closing an electric circuit between a pair of contacts or detecting an infrared radiation or detecting the presence of an earlobe.

5. The system as claimed in claim 1, wherein the first input controller is selected from the group of an electromechanical sensor, an electronic sensor, an electro-optical sensor, an infrared sensor, a laser beetle, or a speaker that transduces the audio, used as a microphone.

6. The system as claimed in claim 1, wherein a first position controller includes selection of an application using the position detection of first earpiece being in or out of position for media content selecting/rendering.

7. The system as claimed in claim 6, wherein a first position controller further uses at least one predetermined length of time for the position detection of the first earpiece being in or out of position for media content selecting/rendering.

8. The system as claimed in claim 6, wherein the system uses the first and second position controllers to select an application using the position detection of first and second earpiece being in or out of position for media content selecting/rendering.

9. The system as claimed in claim 8, wherein the system uses the first and second position controllers and at least one predetermined length of time for the position detection of the first and second earpieces being in or out of position for media content rendering

10. A system for controlling a device comprising: at least one earpiece for selecting an application for the device, wherein a first earpiece includes a first position controller for detecting the first earpiece and receiving input to select the application; wherein the system is arranged to use a position detection from the first position controller to enable selection of an application.

11. A method of controlling a device using at least one earpiece for selecting/rendering media content, wherein a first earpiece includes a first input controller, a first position controller, the method comprising the steps of:
detecting the first earpiece, using the first position controller;
receiving input to control the selecting/rendering of the media content, using the first position controller;
receiving input to control the selecting/rendering of the media content, using the first input controller; and
enabling control of the media content selecting/rendering using a position detection from the first position controller or a combination of a position detection from the first position controller and an input from the first input controller.

12. A method of controlling a device using at least one earpiece for selecting an application process on the device, wherein a first earpiece includes a first position controller, the method comprising the steps of:
detecting the first earpiece, using the first position controller;
receiving input to select an application, using the first position controller; and
enabling control of the device for the selection of the an application using a position detection from the first position controller.
